(19) United States
(12) Patent Application Publication
(10) Pub. No.: US 2004/0268395 A1
(43) Pub. Date: Dec. 30, 2004

(54) Electronic program magazine

(75) Inventor: Hee-Chul Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/767,468

(22) Filed: Jan. 30, 2004

(30) Foreign Application Priority Data
Jan. 30, 2003 (KR) 2003-6285

(51) Int. Cl. H04N 5/445; G06F 3/00; G06F 13/00

(52) U.S. Cl. 725/48; 725/49; 725/50

(57) ABSTRACT

Provided is a method of providing an electronic program magazine through a medium, which is able to receive television signals and access the Internet. The method includes: if an electronic program magazine function is called, checking electronic program guides and search engine tables contained in broadcast signals received from each broadcasting company and composing a total electronic program guide and search engine table; selecting a name of a program that is being broadcasted through the medium or that is selected in an electronic program guide, which is being executed, as a keyword; and executing a default search engine set by the medium and displaying search results obtained by the default search engine using the keyword, wherein the search results are a plurality of hyperlinked web pages.

### BACKGROUND OF THE INVENTION

This application claims the priority of Korean Patent Application No. 2003-6285, filed on Jan. 30, 2003, in the Korean Intellectual Property Office, the disclosure of which is incorporated herein in its entirety by reference.

1. Field of the Invention

The present invention relates to an electronic program magazine, and more particularly, to an electronic program magazine (EPM) based on an improved electronic program guide (EPG) for a digital television.

2. Description of the Related Art

Program and system information protocol (PSIP) tables are carried in an advanced television systems committee (ATSC) stream, which is a digital television broadcast signal. The PSIP includes a virtual channel table (VCT), an electronic program guide (EPG), a system time table, a rating region table, a master guide table (MGT), and so on. The EPG is becoming increasingly important as digital televisions are growing in popularity. In specific, the EPG is an aid for channel navigation, and is composed of at least four event information tables (EITs), which list television programs for virtual channels described in the VCT. A set-top box (STB) necessary for receiving digital television broadcast signals can use EIT information for actual and virtual channel tuning. The VCT and the EITs can work in concert to provide this service via the MGT. The MGT defines sizes, processor identifiers (PIDs), and version numbers of all of the relevant tables comprising the PSIP.

Up to now, the domestic broadcasting system has not provided a complete EPG, and some broadcasting companies bring empty EPG tables via the Internet on websites of the broadcasting companies. Further, the domestic EPG solely shows a timetable and brief descriptions of programs, since program guides illustrated in newspapers are transported to the televisions exactly as they are.

FIG. 1 is a diagram illustrating an example of the EPG table. Referring to FIG. 1, a column 10 shows broadcasting companies that provide programs, and a row 12 shows time slots. Cells 13 of the table show the programs by respective time slots provided by the broadcasting companies. For more information on a specific program, a user clicks a mouse button on a cell of the desired program using a remote controller.

For example, if the user clicks the mouse button on a cell 14 of a program entitled “The Time of the Wild”, detailed information about the program “The Time of the Wild” is displayed on a screen, as shown in FIG. 2, and a button 20 allowing access to a website appears on a right upper corner of the screen.

If the user clicks on the button 20 using the remote controller, a web browser is executed and the Internet home page of the pertinent program is displayed on the screen. If the user wishes to obtain various information on the program, the user should enter uniform resource locators (URLs) of any other related websites directly or find a search engine and then enter a keyword into an input field of the search engine to search the websites.

However, there is a disadvantage to using the conventional technology. In specific, one Internet site is connected to one program, and if the user wishes to search other websites, he/she must directly enter a URL of a search engine and a keyword.

### SUMMARY OF THE INVENTION

The present invention provides an electronic program magazine, which enables a viewer of an EPG or a broadcast program to obtain information on the program from a plurality of websites featuring the program as if he or she is reading a magazine.

According to an aspect of the present invention, there is provided a method of providing an electronic program magazine through a medium, which is able to receive television signals and access the Internet, the method comprising: if an electronic program magazine function is called, checking electronic program guides and search engine tables contained in broadcast signals received from each broadcasting company and composing a total electronic program guide and search engine table; selecting a name of a program that is being broadcasted through the medium or that is selected in an electronic program guide, which is being executed, as a keyword; and executing a default search engine set by the medium and displaying search results obtained by the default search engine using the keyword, wherein the search results are a plurality of hyperlinked web pages.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating an example of an electronic program guide (EPG) table;

FIG. 2 is a diagram illustrating an example of detailed information on an item selected from the EPG table;

FIG. 3 is a flow chart of a method of providing an electronic program magazine (EPM) according to a preferred embodiment of the present invention; and

FIG. 4 is a diagram illustrating an example of search results obtained after inputting a keyword.

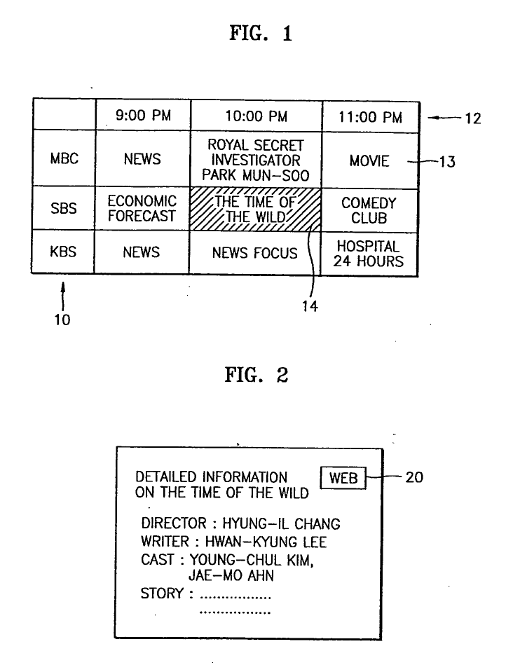

### DETAILED DESCRIPTION OF THE INVENTION

The present invention will now be described more fully with reference to the accompanying drawings, in which preferred embodiments of the invention are shown.

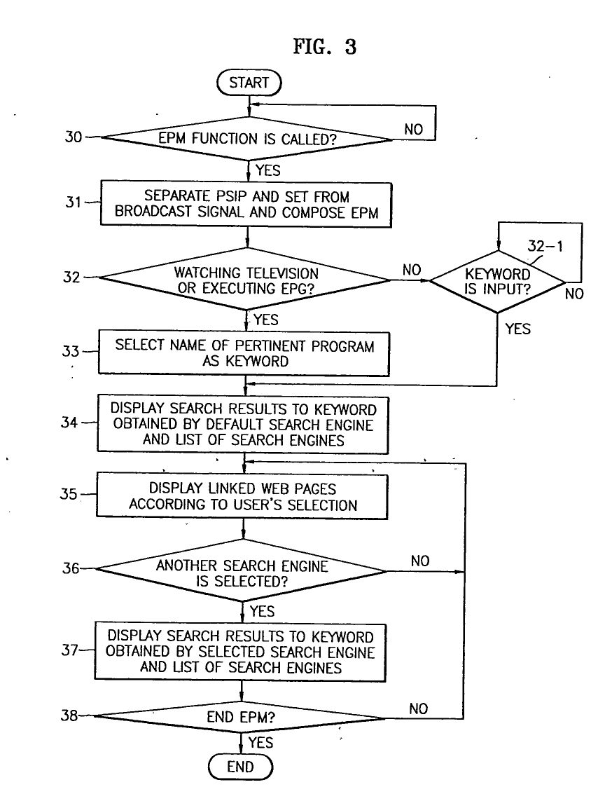

FIG. 3 is a flow chart of a method of providing an electronic program magazine (EPM) according to a preferred embodiment of the present invention. The method is for providing the EPM to a user through a medium, e.g., digital television, able to receive advanced television systems committee (ATSC) signals and access the Internet.

In step 30, it is determined whether the user calls an EPM function. If it is determined in step 30 that the user calls the EPM function, in step 31, the medium checks program and system information protocol (PSIP) tables and search engine tables (SETs) contained in ATSC signal streams received from various broadcasting companies and separates a PSIP and a SET from each of the streams. Here, the SET is a list of a plurality of search engines which each of the broadcasting companies considers advantageous and thus selects from existing search engines so as to be added to the PSIP. The user can call the EPM function, for example, by pressing an EPM button that is shown in a menu of a remote controller or a television.

Table 1 shows an example of the SET.

A cell of an ID in the table represents an identification number. Each search engine has its own ID. Nation and Language cells respectively show nations using the search engines and languages used in the search engines. A Search Engine Name cell shows commonly used names of the search engines, and a Search Engine Web Address cell shows addresses of the search engines which can be searched right after a keyword is attached thereto. It should be appreciated that the Search Engine Web Address cell does not represent the common web addresses of the search engines. For example, the web address of Naver is not http://www.naver.com but an address that waits for an input of a specific keyword. This will be explained in detail below.

TABLE 1

| | | | Search Engine | | |
|---|---|---|---|---|---|
| ID | Nation | Language | Name | Search Engine Web Address | Description |
| 51 | Korea | Korean | Empas | http://search.empas.com/search/all.html?q= | Search engine supporting natural |
| | | | | | language search and provider of |
| | | | | | directory service, image search, sound |
| | | | | | search, mp3 file search |
| 52 | Korea | Korean | Naver | http://search.naver.com/search.naver?where=n | Korea's web site search engine and |
| | | | | exearch&query= | provider of classification service |
| 53 | America | English | Yahoo | http://search.yahoo.com/bin/search?p= | Provider of comprehensive online |
| | | | | | service to consumers and businesses |
| | | | | | worldwide |

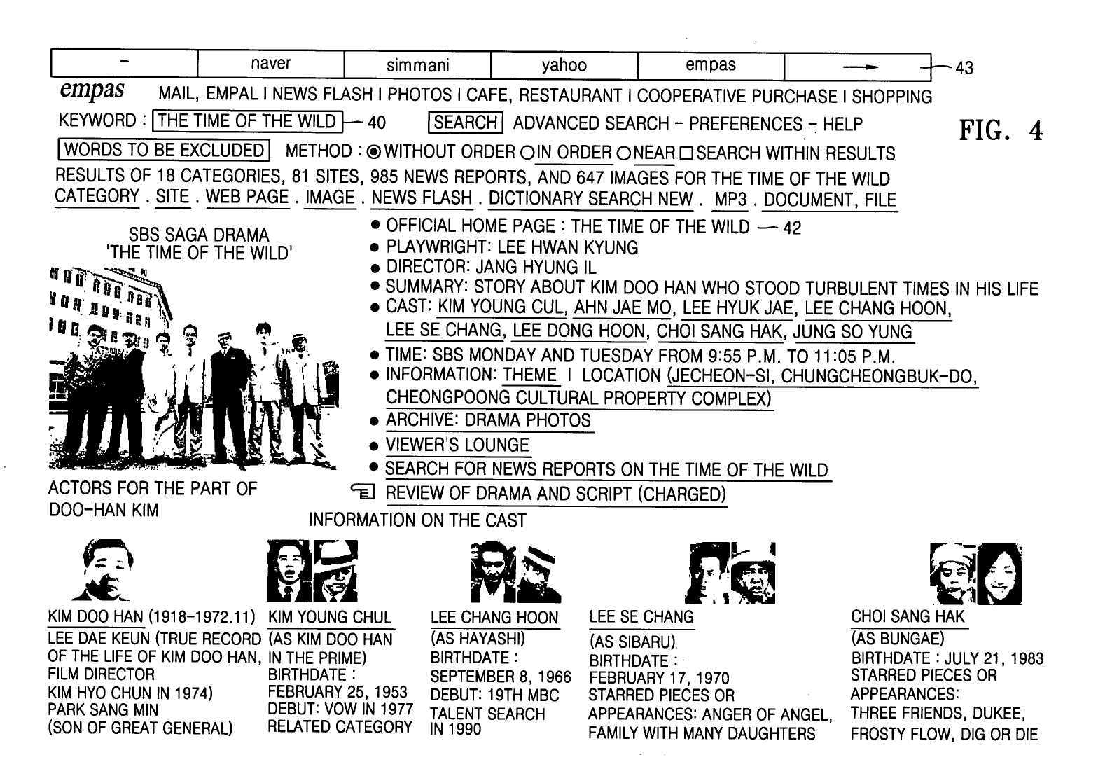

The medium removes repeated IDs shown in the SETs transmitted from the various broadcasting companies and composes a total electronic program guide (EPG) and a total SET from the EPGs included in the PSIPs and the SETs to compose the EPM. In step 32, the medium determines whether the user is watching television or executing the EPG. If it is determined in step 32 that the user is watching television or executing the EPG, in step 33, a name of the pertinent program is selected as a keyword. If it is determined in step 32 that the user is neither watching the television nor executing the EPG, in step 32-1, the medium receives a keyword from the user. If the name of the pertinent program is selected as the keyword in step 33 or if the keyword is received from the user in step 32-1, in step 34, the medium executes a web browser of a default search engine, displays search results to the keyword, and also displays a list of search engines provided by the total SET. Here, the default search engine may be a search engine having the lowest ID value or a search engine designated by the user. FIG. 4 is a diagram illustrating an example of search results obtained using the keyword. That is, if the user who is watching a program, “The Time of the Wild” or executing the EPG, clicks on “The Time of the Wild”, or inputs a keyword, “The Time of the Wild”, search results to the keyword 40, “The Time of the Wild”, are displayed as shown in FIG. 4. The list 43 of search engines is also displayed as shown in FIG. 4. Various hyperlinked words and phrases are present in the displayed search results. In step 35, if the user selects desired words and phrases from the various hyperlinked words and phrases, the medium enables the user to access web pages to which the selected words and phrases are linked. In step 36, if the user wishes to obtain information through another search engine and clicks on a name of the another search engine, the medium displays search results to the keyword, which is obtained by the selected search engine, and the list of search engines in step 37. In step 38, it is determined whether the user ends the EPM. If it is determined in step 38 that the user ends EPM, the medium ends the EPM.

On the other hand, the medium provides an interface through which the user's favorite search engines can be registered in addition to the list of search engines sent by the respective broadcasting companies. The user is asked the following questions through the interface and the user's answers are registered in the SET.

a. Nation:

b. Language:

c. Search engine name:

d. Search engine web address:

e. Description:

It is preferable that numbers assigned to IDs of the search engines selected by the user begin with a sufficiently distinguishable number, e.g., 1000, from the numbers assigned to the IDs of the search engines sent by the broadcasting companies.

As described above, in contrast to the conventional art in which one program is connected to only one internet site and the user must directly enter a URL of a search engine to perform a search, the EPM according to the present invention is advantageous in that even though the user does not know the URL of the search engine, a search engine is automatically executed and a name of a program which is being broadcast or is selected in the executed EPG is automatically entered as a keyword, thereby obtaining information on the program from a plurality of linked web pages as if the user is reading a magazine. Furthermore, the user can select search engines other than the displayed search engines, thereby ensuring a more convenient user interface. On the other hand, the respective broadcasting companies can advantageously select search engines and provide the selected search engines to the user, allowing the user to obtain higher quality information. The user can also directly register his or her favorite search engines.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of providing an electronic program magazine through a medium, which is able to receive television signals and access the Internet, the method comprising:
checking electronic program guides and search engine tables contained in broadcast signals received from at least one broadcasting company and composing a total electronic program guide and search engine table;
setting a keyword, the setting of the keyword comprising selecting a name of a program as the keyword; and
executing a default search engine and displaying search results obtained by the default search engine using the keyword,
wherein the search results are a plurality of hyperlinked web pages.

2. The method of claim 1, wherein each of the search engine tables is a list of a plurality of search engines which each of the broadcasting companies selects among existing search engines.

3. The method of claim 2, wherein the search engines included in the search engine table are input from a user and registered to a search engine list.

4. The method of claim 1, wherein the search engines included in the search engine table are input from a user and registered to a search engine list.

5. The method of claim 1, wherein the setting of the keyword comprises receiving the keyword from a user if a program is not being broadcasted and the electronic program guide is not executed.

6. The method of claim 1, wherein the medium enables a user to access the hyperlinked web pages according to the user's selection.

7. The method of claim 1, wherein the medium displays all of the search engines shown in the search engine tables in addition to a web page of the search results.

8. The method of claim 7, wherein if another search engine is selected among the search engine list, search results obtained by the selected search engine using the keyword are displayed.

9. The method of claim 1, wherein the setting of the keyword comprises selecting a name of a program that is being broadcasted through the medium or that is selected in an electronic program guide, which is being executed, as the keyword.

10. The method of claim 1, wherein the medium comprises a digital television receiving advanced television systems committee (ATSC) signal and having access to the Internet.

11. The method of claim 1, wherein the checking comprises checking electronic program guides and search engine tables contained in broadcast signals received from each of a plurality of broadcasting companies.

12. The method of claim 1, further comprising judging if an electronic magazine program function is called by a user, wherein the checking is performed only if the electronic magazine function is called.

13. The method of claim 1, wherein composing the total electronic program guide and search engine table comprises:
separating electronic program guides and search engine tables from the received broadcast signals;
removing duplicative search engines from the separated search engine tables; and
including the separated electronic program guides and search engines, which were not removed, in the total electronic program guide and search engine table.

14. The method of claim 1, wherein the default search engine is set by the medium.

15. The method of claim 1, wherein the default engine is set by a user.
